(19) United States
(12) Patent Application Publication
(10) Pub. No.: US 2023/0281648 A1
(43) Pub. Date: Sep. 7, 2023

(54) SYSTEMS AND METHODS FOR COLLECTION AND PROCESSING OF TRANSACTIONAL DATA

(71) Applicant: JPMORGAN CHASE BANK, N.A., New York, NY (US)

(72) Inventors: Eric CONNOLLY, Kennett Square, PA (US); Brian YOUNG, New York, NY (US); Pavani RAO, Frisco, TX (US); Julia ELYASHEVA, Woodmere, NY (US); Sudharsan SELVAKUMAR, Irving, TX (US); Bryan JEON, Allen, TX (US); Aditya CHEBIYYAM, McKinney, TX (US); Sean ZHANG, Plano, TX (US)

(21) Appl. No.: 18/174,848

(22) Filed: Feb. 27, 2023

Related U.S. Application Data
(60) Provisional application No. 63/268,900, filed on Mar. 4, 2022.

(51) Int. Cl. G06Q 30/0202; G06V 30/412; G06V 30/10

(52) U.S. Cl. CPC G06Q 30/0202; G06V 30/412; G06V 30/10

(57) ABSTRACT

Techniques for collection and processing of transactional data are disclosed. An exemplary method includes receiving, at a capture module, a document; determining, by an aggregation engine, a plurality of transactions recorded in the document; categorizing, by the aggregation engine, the plurality of transactions into categorized transactional data; storing the categorized transactional data in a storage module; publishing consumption application programming interfaces (APIs); and providing the categorized transactional data for consumption via the consumption APIs.

### BACKGROUND

### 1. Field of the Invention

The invention relates generally to systems and methods for collection and processing of transactional data, in accordance with aspects.

### 2. Description of the Related Art

Current document capture products available are developed generally either for determining consumer reward offers based on receipt data or for processing business expense reconciliation. A receipt product that caters to both consumer and business users, while also allowing the provider to use a capture module of the product, and a storage container (i.e., a digital lockbox concept) with categorizing capabilities, would be advantageous for driving customer services.

### SUMMARY

In some aspects, the techniques described herein relate to a method including: receiving, at a capture module, a document; determining, by an aggregation engine, a plurality of transactions recorded in the document; categorizing, by the aggregation engine, the plurality of transactions into categorized transactional data; storing the categorized transactional data in a storage module; publishing consumption application programming interfaces (APIs); and providing the categorized transactional data for consumption via the consumption APIs.

In some aspects, the techniques described herein relate to a method, further including: processing the categorized transactional data with a data services module including a machine learning model.

In some aspects, the techniques described herein relate to a method, wherein the capture module includes an optical character recognition engine.

In some aspects, the techniques described herein relate to a method, including: performing optical character recognition on the document.

In some aspects, the techniques described herein relate to a method, wherein an output of processing the categorized transactional data is predictions based on patterns identified in the categorized transactional data.

In some aspects, the techniques described herein relate to a method, wherein the predictions include a service or product.

In some aspects, the techniques described herein relate to a method, wherein the service or product is provided for consumption by a user device via the consumption APIs.

In some aspects, the techniques described herein relate to a system including at least one computer including a processor, wherein the at least one computer is configured to: receive, at a capture module, a document; determine, by an aggregation engine, a plurality of transactions recorded in the document; categorize, by the aggregation engine, the plurality of transactions into categorized transactional data; store the categorized transactional data in a storage module; publish consumption application programming interfaces (APIs); and provide the categorized transactional data for consumption via the consumption APIs.

In some aspects, the techniques described herein relate to a system, wherein the at least one computer is configured to: process the categorized transactional data with a data services module including a machine learning model.

In some aspects, the techniques described herein relate to a system, wherein the capture module includes an optical character recognition engine.

In some aspects, the techniques described herein relate to a system, wherein the at least one computer is configured to: perform optical character recognition on the document.

In some aspects, the techniques described herein relate to a system, wherein an output of processing the categorized transactional data is predictions based on patterns identified in the categorized transactional data.

In some aspects, the techniques described herein relate to a system, wherein the predictions include a service or product.

In some aspects, the techniques described herein relate to a system, wherein the service or product is provide for consumption by a user device via the consumption APIs.

In some aspects, the techniques described herein relate to a non-transitory computer readable storage medium, including instructions stored thereon, which instructions, when read and executed by one or more computer processors, cause the one or more computer processors to perform steps including: receiving, at a capture module, a document; determining, by an aggregation engine, a plurality of transactions recorded in the document; categorizing, by the aggregation engine, the plurality of transactions into categorized transactional data; storing the categorized transactional data in a storage module; publishing consumption application programming interfaces (APIs); and providing the categorized transactional data for consumption via the consumption APIs.

In some aspects, the techniques described herein relate to a non-transitory computer readable storage medium, further including: processing the categorized transactional data with a data services module including a machine learning model.

In some aspects, the techniques described herein relate to a non-transitory computer readable storage medium, wherein the capture module includes an optical character recognition engine.

In some aspects, the techniques described herein relate to a non-transitory computer readable storage medium, including: performing optical character recognition on the document.

In some aspects, the techniques described herein relate to a non-transitory computer readable storage medium, wherein an output of processing the categorized transactional data is predictions based on patterns identified in the categorized transactional data.

In some aspects, the techniques described herein relate to a non-transitory computer readable storage medium, wherein the predictions include a service or product, and wherein the service or product is provided for consumption by a user device via the consumption APIs.

### BRIEF DESCRIPTION OF THE DRAWINGS

FIG. 1 is a block diagram of a system for collection and processing of transactional data, in accordance with aspects.

FIG. 2 is a logical flow for collection and processing of transactional data, in accordance with aspects.

FIG. 3 is a block diagram of a computing device for implementing certain aspects of the present disclosure.

### DETAILED DESCRIPTION OF EMBODIMENTS

The invention relates generally to systems and methods for collection and processing of transactional data, in accordance with aspects.

In accordance with aspects, an enhanced document capture product that focuses on both individual customers and business users can allow for capturing insights of the user (i.e., the customer) by the provider, and thereby allow increased engagement with the user by the provider. Further, the enhanced receipt product may allow for an improved customer experience across different provider channels and lines of business.

Aspects include a document capture module that can capture paper documents and transform them, via optical character recognition (OCR) into characters or character strings for parsing. Optical character recognition is a process of electronic conversion of images of text into digitally-encoded text using software and optical image/document scanning hardware. OCR processes enable appropriate hardware to convert a scanned document, a digital photo of text, or any another digital image of text into machine-readable, editable data.

Aspects can include an interface to a device's camera for taking pictures of receipts and other paper documents and uploading the documents as image-based documents. Additionally, documents can be ingested through multiple ingestion points. For example, customers—either individuals or business users— can provide documents (including, but not limited to receipts) via a document upload interface. The interface can accept documents having text formats and/or image-based documents. Image-based documents can be processed with OCR modules to generate text from the documents.

In accordance with aspects, natural language processing (NLP) algorithms can be configured to identify stock-keeping unit (SKU) level data from the documents received from the document capture module. SKU data is a number, set of numbers, or an alphanumeric string that identifies a product and allows for tracking of inventory by manufacturers and retailers. SKUs are often printed on product labels as a scannable barcode. SKUs are also often printed on receipts from a retailer. Accordingly, SKUs can be identified and used to provide granular detail into a user's purchase history.

Document data can also be provided through application programming interfaces (APIs) with other third-party vendors. For instance, data aggregators or other receipt-capture vendors can provide an API, and the customer can give consent for a providing organization to access the customer's data through the APIs provided by the third parties. Exemplary third parties that may interface with a digital receipt system include merchants, data aggregators, bookkeeping or reconciliation platforms, etc.

Another exemplary channel for document data collection (and particularly, for receipt data collection) is via point-of-sale (POS) systems. A providing organization may also provide a POS system that can be used by retailers for accepting payment from a customer at the point of sale and providing the customer with a receipt. The receipt can be in electronic form and can be sent to the user through various electronic channels (e.g., email, SMS message, etc.). For customers that are associated with (e.g., have a user account for, and/or access to) the providing organization's digital receipt system/service, receipts from the POS devices provided by the organization can be automatically and seamlessly associated with the user's account.

Other sources of document/transactional data include different channels such as email, ATM usage, web usage, mobile application usage, digital check deposits, deposit transactions, etc. For instance, a digital document/receipt service may include a mobile application that executes on a user's mobile device. The mobile application may act as an interface to the digital document/receipt service. The mobile application can prompt the user for access to an electronic mail (email) application also executing on the user's mobile device, the mobile application can then parse electronic mail stored in the email application to identify digital receipts from merchants. Once a digital receipt is identified, the mobile application can send the digital receipt for storage and processing at the storage module.

Aspects further include a storage module that can store and categorize received documents. The storage module can store documents and associated text derived from documents via the OCR process. The storage module can have APIs that allow services to access the data stored in the storage module. Exemplary services are aggregation services, machine learning services, etc. The storage module can act as a repository of data for machine learning algorithms and modules (referred to herein as “ML models”). ML models can use the data in the storage model for processing and can derive relationships based on the processed data.

In some aspects, transaction details can be added to the storage module that are not associated with a received receipt. Transaction details can be added by users or can be retrieved or received from third parties or from POS devices and systems.

In accordance with aspects, a user interface can display transaction details to a user. The transaction details can be retrieved from the storage module and formatted for display to a user. Matching algorithms can process the data in the storage module. Matching algorithms can be configured to determine if granular transactional data is associated with a received receipt. The user interface can display transactional data that has been associated with a receipt and transactional data that has not been associated with a receipt.

For transactional data that is not associated with a receipt, a user can be prompted to provide a receipt. The user may be prompted to upload the receipt via an image capture, as discussed above, or the user may be prompted to allow or initiate a download of the receipt from a third-party bookkeeping or reconciliation platform. As discussed, above, a third-party platform can be interfaced with the system via one or more APIs.

In accordance with aspects, if both a digital receipt (e.g., from a third-party bookkeeping or reconciliation platform) has been received and a paper receipt has been received, a fraud module can be configured to compare the two receipts and determine discrepancies. If discrepancies are found the user can be alerted to the discrepancies as a possible basis for fraudulent activity.

The storage module can associate data with categories. Exemplary categories include purchase invoices, bank statements, bills of lading, commercial letters, expense reports, tax documents, etc. The categories can be either predefined or user-defined categories. A providing organization can make the data available to multiple lines of business within the organization. Each line of business (LOB) can process the data according to the output it desires to achieve. For example, each LOB can use different ML models to derive different relations for making different predictions and inferences regarding the data.

Different LOBs can provide different operational and analytical data for use by the customer. For example, a providing organization can provide consumer insights to a small business customer of the service. An expense reconciliation platform can be offered to both business and individual users. Budgeting information can also be provided to both small business users and individual customers. Targeted offers and advertising can be provided to individual users. These services are exemplary, and not meant to be limiting.

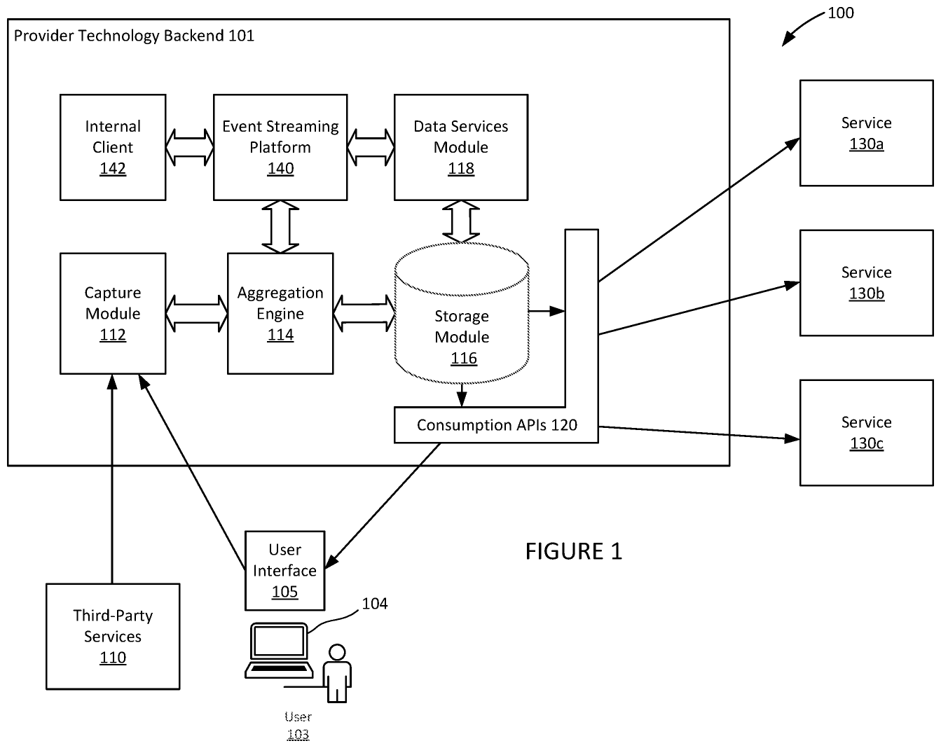

FIG. 1 is a block diagram of a system for collection and processing of transactional data, in accordance with aspects. System 100 includes provider technology backend 101. Provider technology backend 101 may represent the backend technology infrastructure of an organization that provides document/receipt capture and processing services, as described herein. Provider technology backend 101 may include servers, computers, software applications, computer network mediums, and computer networking hardware and software for providing electronic services based on computer software applications executing on requisite hardware. Exemplary hardware and software include webservers, application servers, database servers and database engines, communication servers such as email servers and SMS servers, network routers, switches and firewalls, custom-developed software applications (i.e., computer applications) including hardware to execute such applications on, etc.

System 100 further includes user interface 105 and user electronic device 104. User interface 105 can be a web interface that is accessed through a web browser or a mobile application, each of which may be executed on user electronic device 104. User interface 105 may, alternatively, be any suitable interface for accessing components of system 100. User 103 can access user interface 105 via interaction with user electronic device 104. User electronic device 104 can be communicatively coupled to provider technology backend 101 via a private network or a public network (such as the internet). User electronic device 104 can be a smart phone, a tablet computer, a laptop computer, or any mobile electronic device that is capable of storing and executing a mobile/computer application.

User electronic device 104, third-party services 110, service 130a, service 130b, and service 130c may each be communicatively coupled to provider technology backend 101 (and components operating therein) with appropriate hardware and software. For instance, user electronic device 104 can include a wired or wireless network interface card (NIC) that interfaces with a public network (e.g., the internet) and is configured with appropriate communication protocols. Likewise, third-party services 110, service 130a, service 130b, and service 130c can include hardware (NICs, switches, routers, etc.) configured with appropriate protocols for intercommunication with each other and with user electronic device 104 over a public network.

Capture module 112 can be configured to receive documents, such as receipts, from user interface 105, or from third-party services 110 (each as discussed in detail, above). Capture module 112 can include an OCR engine (not shown) for performing optical character recognition on received imagery documents. Documents received by capture module 112 can be sent to, or retrieved by, aggregation engine 114.

Aggregation engine 114 can prepare documents for storage in storage module 116. Aggregation engine 114 can include a natural language processing engine (not shown) which can process text from received documents and categorize identified transactions for storage in storage module 116. In accordance with embodiments, storage module 116 may be any appropriate or desirable storage solution, such as a relational data base, an online transactional data base, a data lake, etc. In some aspects, storage module 116 can include a combination of appropriate or desirable storage solutions.

Once transaction data is persisted in storage module 116, data services module 118 can process the data. For example, data services module 118 can include ML models trained to identify patterns in the transactional data and infer relationships and make predictions based on the identified patterns. An exemplary use of ML models is for predicting advertising or products that are relevant to a user based on the user's previous transactions stored in storage module 116.

Consumption APIs 120 can be configured to allow access and consumption of the transactional data and information stored in storage module 116. For instance, user 103 can access and consume information related to user 103's transactions via consumption APIs 120. Exemplary services for consumption via consumption APIs 120 can include consumer insights for small business customers, budgeting for small business or individual customers, relevant advertisements of ads for small business or individual customers, expense reconciliation services, bookkeeping services, etc.

Third-party services may be configured to consume data and information from consumption APIs as well. For instance, a small business customer, may subscribe to third-party services such as accounting services, tax preparation services, etc. Such third-party services may benefit from access to the transactional data stored in storage module 116 and may be configured to access the data via consumption APIs 120 (e.g., with user credentials supplied by user 103). Service 130a, service 130b, and service 130c represent various third-party services that may consume data from consumption APIs 120 in order to enhance user 103's experience while engaging with the third-party service.

In accordance with aspects, systems described herein may provide one or more application programming interfaces (APIs) in order to facilitate communication with related/provided applications and/or among various public or partner technology backends, data centers, or the like. APIs may publish various methods and expose the methods via API gateways. A published API method may be called by an application that is authorized to access the published API methods. API methods may take data as one or more parameters of the called method. API access may be governed by an API gateway associated with a corresponding API. Incoming API method calls may be routed to an API gateway and the API gateway may forward the method calls to internal API servers that may execute the called method, perform processing on any data received as parameters of the called method, and send a return communication to the method caller via the API gateway. A return communication may also include data based on the called method and its data parameters.

API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

With reference to FIG. 1, event streaming platform 140 may receive events from aggregation engine 114 and event streaming platform 140 may stream events to services and clients that are internal to provider technology backend 101. Aggregation engine 114 may be any suitable distributed event streaming platform 140 (e.g., Apache Kafka®) for handling of associated events in the form of real time and near-real time streaming data to/from streaming data pipelines and/or streaming applications.

Streaming data is data that is continuously generated by a data source. An event streaming platform 140 can receive streaming data from multiple sources and process the data sequentially and incrementally. Event streaming platforms 140 can be used in conjunction with real time and near-real time streaming data pipelines and streaming applications. For example, an event streaming platform 140 can ingest and store streaming data from the data pipeline and provide the data to an application that process the streaming data. An event streaming platform 140 may include partitioned commit logs (each, an ordered sequence of records) to store corresponding streams of records. The logs are divided into partitions, and a subscriber can subscribe to a “topic” that is associated with a partition, and thereby receive all records stored at the partition (e.g., as passed to the subscriber in real time by the platform).

An event streaming platform 140 may expose a producer API that publishes a stream of records to a topic, and a consumer API that a consumer application can use to subscribe to topics and thereby receive the record stream associated with that topic. An event streaming platform 140 may also publish other APIs with necessary or desired functionality.

Aggregation engine 114 may be configured to stream incoming data from capture module 112 to event streaming platform 140 via a producer API. Event streaming platform 140 may publish the stream as a topic (e.g., a “transaction” topic) for consumption via a consumer API. Internal client 142 and data services module 118 may be exemplary consumers of incoming data via event streaming platform 140. In an exemplary aspect, data services module 118 may subscribe to a transaction topic published by event streaming platform 140 and may process the data stream with ML models, as described herein. Topics streamed may include account balances, transaction posts, etc.

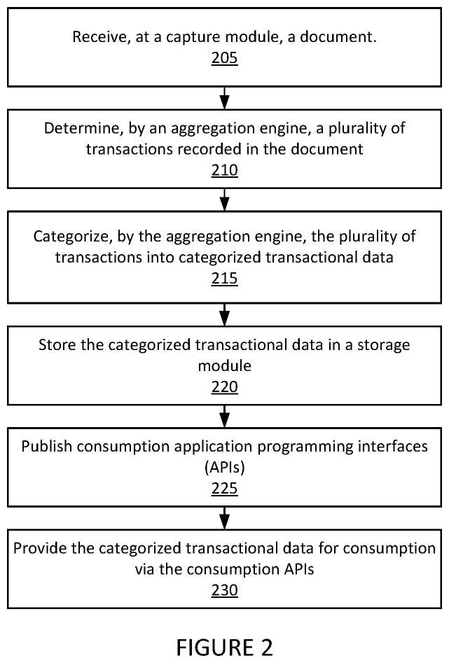

FIG. 2 is a logical flow for collection and processing of transactional data, in accordance with aspects. At step 205, a capture module can receive a document. At step 210, an aggregation engine can determine a plurality of (i.e., two or more) transactions recorded in the document. At step 215, the aggregation engine can categorize the plurality of transactions into categorized transactional data. At step 220, the categorized data can be stored in a storage module. At step 225, consumption APIs can be published. At step 230, the categorized transactional data can be provided for consumption via the consumption APIs.

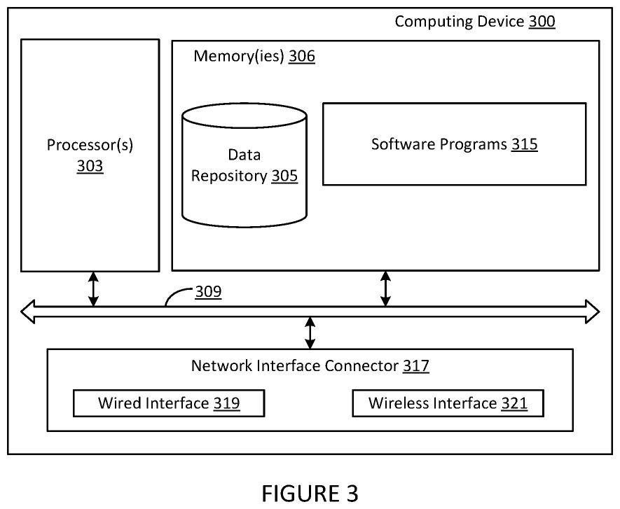

FIG. 3 is a block diagram of a computing device for implementing certain aspects of the present disclosure. FIG. 3 depicts exemplary computing device 300. Computing device 300 may represent hardware that executes the logic that drives the various system components described herein. For example, system components such an aggregation engine, a capture module, an event streaming platform, a data services module, a mobile electronic device, database engines and database servers, and other computer applications and logic may include, and/or execute on components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a micro-processor and/or in the form of statically or dynamically programmed electronic circuitry.

The system of the invention or portions of the system of the invention may be in the form of a “processing machine” a “computing device,” or an “electronic device” etc. These may be a general-purpose computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software. In one aspect, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method for collection and processing of transactional data comprising:
receiving, at a capture module, a document;
determining, by an aggregation engine, a plurality of transactions recorded in the document;
categorizing, by the aggregation engine, the plurality of transactions into categorized transactional data;
storing the categorized transactional data in a storage module;
publishing consumption application programming interfaces (APIs); and
providing the categorized transactional data for consumption via the consumption APIs.

2. The method of claim 1, further comprising:
processing the categorized transactional data with a data services module including a machine learning model.

3. The method of claim 1, wherein the capture module includes an optical character recognition engine.

4. The method of claim 3, comprising:
performing optical character recognition on the document.

5. The method of claim 2, wherein an output of processing the categorized transactional data is predictions based on patterns identified in the categorized transactional data.

6. The method of claim 5, wherein the predictions include a service or product.

7. The method of claim 6, wherein the service or product is provided for consumption by a user device via the consumption APIs.

8. A system comprising at least one computer including a processor, wherein the at least one computer is configured to:
receive, at a capture module, a document;
determine, by an aggregation engine, a plurality of transactions recorded in the document;
categorize, by the aggregation engine, the plurality of transactions into categorized transactional data;
store the categorized transactional data in a storage module;
publish consumption application programming interfaces (APIs); and
provide the categorized transactional data for consumption via the consumption APIs.

9. The system of claim 8, wherein the at least one computer is configured to:
process the categorized transactional data with a data services module including a machine learning model.

10. The system of claim 8, wherein the capture module includes an optical character recognition engine.

11. The system of claim 10, wherein the at least one computer is configured to:
perform optical character recognition on the document.

12. The system of claim 9, wherein an output of processing the categorized transactional data is predictions based on patterns identified in the categorized transactional data.

13. The system of claim 12, wherein the predictions include a service or product.

14. The system of claim 13, wherein the service or product is provide for consumption by a user device via the consumption APIs.

15. A non-transitory computer readable storage medium, including instructions stored thereon for collection and processing of transactional data for collection and processing of transactional data, which instructions, when read and executed by one or more computer processors, cause the one or more computer processors to perform steps comprising:
receiving, at a capture module, a document;
determining, by an aggregation engine, a plurality of transactions recorded in the document;
categorizing, by the aggregation engine, the plurality of transactions into categorized transactional data;
storing the categorized transactional data in a storage module;
publishing consumption application programming interfaces (APIs); and
providing the categorized transactional data for consumption via the consumption APIs.

16. The non-transitory computer readable storage medium of claim 15, further comprising:
processing the categorized transactional data with a data services module including a machine learning model.

17. The non-transitory computer readable storage medium of claim 15, wherein the capture module includes an optical character recognition engine.

18. The non-transitory computer readable storage medium of claim 17, comprising:
performing optical character recognition on the document.

19. The non-transitory computer readable storage medium of claim 16, wherein an output of processing the categorized transactional data is predictions based on patterns identified in the categorized transactional data.

20. The non-transitory computer readable storage medium of claim 19, wherein the predictions include a service or product, and wherein the service or product is provided for consumption by a user device via the consumption APIs.
